(19) United States
(12) Patent Application Publication
(10) Pub. No.: US 2005/0168465 A1
(43) Pub. Date: Aug. 4, 2005

(54) Computer graphics system, computer graphics reproducing method, and computer graphics program

(76) Inventor: Setsuji Tatsumi, Kanagawa (JP)

Correspondence Address: Whitham, Curtis & Christofferson, P.C., Suite 340, 11491 Sunset Hills Road, Reston, VA, 20190, US

(21) Appl. No.: 10/948,845

(22) Filed: Sep. 24, 2004

(30) Foreign Application Priority Data
Sep. 24, 2003 (JP) 2003-332134

(51) Int. Cl. G06T 15/50

(52) U.S. Cl. 345/426

(57) ABSTRACT

A computer graphics system has a monitor, a database unit, an input section and an operational section. The database unit stores at least one set of lighting member information on a lighting member for controlling light incident on the object and optical characteristic information on optical characteristics of the lighting member. The input section inputs and instructs shape information, surface information and positional information of the object, light source information of a light source, viewpoint information, information on a kind of the lighting member, and positional information of the lighting member. The operational section generates image data of the object based on these information to be displayed as the two-dimensional image on a screen of the monitor. A computer graphics system displays a three-dimensional image of the object created in a virtual three-dimensional coordinate space on the screen as a two-dimensional image of the object.

### BACKGROUND OF THE INVENTION

The present invention relates to a computer graphics system, which can reproduce photo studio lighting for taking commercial photos and prepare a computer graphics image excellent in textural depiction. In addition, the present invention relates to a computer graphics reproducing method and a computer graphics program.

Conventionally, computer graphics (hereinafter, referred to simply as CG) allows display of a three-dimensional object image on a screen of a display device. According to the computer graphics, light reflected toward the viewpoint direction of an observer from the surface of an object mapped on three-dimensional coordinates in a CG virtual space (simulated space) is calculated using ray tracing, whereby the object image is generally reproduced on a display screen in the following manner. More specifically, the luminance of an object image observed by the observer is calculated, and thereafter, converted into a two-dimensional image corresponding to luminance information to be displayed on the display device. In order to obtain a more real image, there have been known various methods of displaying images taking into consideration multiple reflection between objects or scattering on the object surface.

In the conventional CG, various kinds of light sources are registered; for example, point, line, and plane light sources are given as the light source. The position and spectral radiant intensity of the light source may be set.

JP 7-129795 A discloses a CG system capable of readily changing lighting effects of a displayed image.

According to the CG system disclosed in JP 7-129795 A, a user can directly set lighting effects in the displayed image, for example, a highlight position and its brightness by using input means. Thus, in the CG system disclosed in JP 7-129795 A, the direction, position, luminance, etc. of the light source are automatically calculated to realize the lighting effects, thereby changing the lighting effects of the displayed image. Therefore, the user can readily obtain desired lighting effect.

It is significant in the CG to obtain an image excellent in textural depiction such as transparent, three-dimensional, and glossy effects as given in the commercial photo. However, according to the conventional CG, the kind and position of the light source are only set; for this reason, there is a problem in that an image excellent in textural depiction cannot be obtained. As a result, the know-how to obtain the image excellent in textural depiction is required. In addition, trial and error are also required in order to obtain the image excellent in textural depiction.

In the CG system disclosed in JP 7-129795 A, the highlight position is directly set so that a user can obtain a desired lighting effects. However, even if the highlight position and its brightness are adjusted, it is not sufficient to obtain an image excellent in textural depiction such as transparent, three-dimensional and glossy effects. For this reason, there is a problem in that it is difficult to obtain an image which has the same textural depiction as that of the commercial photo.

### SUMMARY OF THE INVENTION

The present invention has been made in order to solve the problem based on the prior art, and therefore has an object to provide a computer graphic system, which can readily obtain a high-texture image, a computer graphics reproducing method, and a computer graphics program.

In order to attain the above-mentioned object, a first aspect of the present invention provides a computer graphics system displaying a three-dimensional image of an object created in a virtual three-dimensional coordinate space on a screen of a display device as a two-dimensional image of the object, comprising: a database unit which stores at least one set of lighting member information on a lighting member for controlling light incident on the object arranged in the virtual three-dimensional coordinate space and optical characteristic information on optical characteristics of the lighting member; input means which inputs and instructs shape information of the object created in the virtual three-dimensional coordinate space, surface information of the object, positional information of the object within the virtual three-dimensional coordinate space, light source information of a light source arranged in the virtual three-dimensional coordinate space, viewpoint information for displaying the object as the two-dimensional image, information on a kind of the lighting member, and positional information of the lighting member arranged in the virtual three-dimensional coordinate space; and an operational section which generates image data of the object to be displayed as the two-dimensional image on the screen based on the shape information of the object, the surface information of the object, the positional information of the object, the light source information, the viewpoint information, the lighting member information, the optical characteristic information of the lighting member, and the positional information of the lighting member.

It is preferable that the input means comprise an input section for inputting at least one of the light source information on the light source arranged in the virtual three-dimensional coordinate space and the lighting member information, and the input section is displayed on the screen of the display device.

It is preferable that the lighting member comprise one of a diffuse transmission plate and a reflection plate.

It is preferable that the optical characteristics of the lighting member be expressed using one of a bidirectional reflection distribution function and a transmittance distribution function.

It is preferable that the light source information comprise information on a type of the light source and positional information in the virtual three-dimensional coordinate space.

In order to attain the above-mentioned object, a second aspect of the present invention provides a computer graphics reproducing method for displaying a three-dimensional image of an object created in a virtual three-dimensional coordinate space on a screen of a display device as a two-dimensional image of the object, comprising the steps of: setting shape information and surface information of the object, and positional information of the object in the virtual three-dimensional coordinate space; setting light source information which includes type information of a light source arranged in the virtual three-dimensional coordinate space and positional information indicating an arrangement position of the light source in the virtual three-dimensional coordinate space; setting lighting member information of a lighting member for controlling light incident on the object, optical characteristic information on optical characteristics of the lighting member, and positional information of the lighting member indicating an arrangement position of the lighting member; modeling the object based on the set shape information of the object to obtain object model data; rendering the object model data based on the light source information, the lighting member information, the optical characteristic information of the lighting member, and the positional information of the lighting member; and displaying the object on the screen as the two-dimensional image based on image data obtained from the rendering.

It is preferable that the optical characteristics of the lighting member be expressed using one of a bidirectional reflection distribution function and a transmittance distribution function.

In order to attain the above-mentioned object, a third aspect of the present invention provides a computer graphics program for creating image data for displaying a three-dimensional image of an object created in a virtual three-dimensional coordinate space on a screen of a display device as a two-dimensional image, running on a computer graphics system including the display device and a computer, the computer graphics program comprising the steps of: modeling the object based on shape information of the object having been set through inputting to obtain object model data; rendering the object model data based on positional information of the object in the virtual three-dimensional coordinate space, surface information of the object, inputted information on a light source, lighting member information on a lighting member for controlling light incident on the object, information on optical characteristics of the lighting member, positional information of the lighting member in the virtual three-dimensional coordinate space; and displaying the object on the screen as the two-dimensional image based on image data obtained from the rendering.

It is preferable that the light source information include type information of the light source and positional information indicating a position of the light source arranged in the virtual three-dimensional coordinate space.

It is preferable that the optical characteristics of the lighting member be expressed using one of a bidirectional reflection distribution function and a transmittance distribution function.

According to the present invention, a computer graphics system is provided with a database unit. The database unit stores at least one set of lighting member information on a lighting member for controlling light incident on the object arranged in the virtual three-dimensional coordinate space and optical characteristics information on optical characteristics of the lighting member. A light source and lighting members are arranged at a predetermined position in a virtual three-dimensional coordinate space. Thereafter, an operational section generates image data of the object displayed as a two-dimensional image on a screen of a display device. By doing so, it is possible to reproduce the same lighting as a photo studio, and thus, to create a CG image. Therefore, an image excellent in texture may be obtained. In addition, lighting members are arranged at a predetermined position in the virtual three-dimensional coordinate space, thereby making it possible to readily obtain an image excellent in texture.

According to the present invention, a computer graphics reproducing method includes the steps of: modeling the object based on information set on the shape of the object; carrying out rendering based on object model data obtained from the modeling, information on the light source, information on the lighting member and on its optical characteristics; and displaying the object on the screen as a two-dimensional image based on image data obtained from the rendering. Thus, it is possible to reproduce the same lighting as a photo studio, and thus, to create a CG image. Therefore, an image excellent in texture may be obtained. In addition, lighting members are arranged at a predetermined position in the virtual three-dimensional coordinate space, thereby making it possible to readily obtain an image excellent in texture.

This application claims priority on Japanese patent application No.2003-332134, the entire contents of which are hereby incorporated by reference.

### BRIEF DESCRIPTION OF THE DRAWINGS

In the accompanying drawings:

FIG. 1 is a block diagram showing a configuration of a computer graphics system according to one embodiment of the present invention;

FIG. 2 is a schematic diagram showing an optical model of a spotlight;

FIG. 3 is a schematic diagram to explain an optical characteristic of a reflection plate;

FIG. 4 is a schematic diagram to explain an optical characteristic of a diffuse transmission plate;

FIG. 5 is a schematic diagram showing types of light source, diffuse transmission plate, and reflection plate stored in a database of this embodiment;

FIGS. 6A and 6B are schematic diagrams showing an example of input means of the computer graphics system of this embodiment;

FIG. 7 is a schematic diagram showing a virtual three-dimensional coordinate space in the computer graphics system of this embodiment;

FIG. 8 is a schematic diagram showing an input section for selecting a studio name registered in the database of this embodiment;

FIG. 9 is a flowchart of a computer graphics reproducing method of this embodiment;

FIG. 10 is a schematic view showing a state in which a light source, a lighting member, and a cake are arranged in the virtual three-dimensional coordinate space in the computer graphics reproducing method of this embodiment; and

FIG. 11 is a schematic view showing a state in which a light source, a lighting member, and a kitchen knife are arranged in the virtual three-dimensional coordinate space in the computer graphics reproducing method according to another embodiment of the present invention.

### DETAILED DESCRIPTION OF THE PREFERRED EMBODIMENTS

A computer graphics system, computer graphics reproducing method, and computer graphics program according to preferred embodiments of the present invention will be described below with reference to the accompanying drawings.

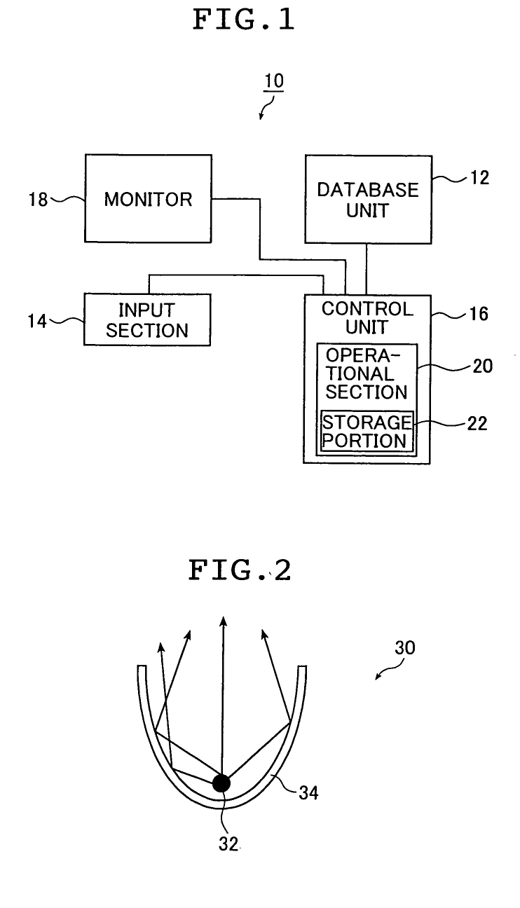

FIG. 1 is a block diagram showing a configuration of a computer graphics system according to one embodiment of the present invention.

As shown in FIG. 1, a computer graphics system (hereinafter, referred to as CG system) 10 includes a database unit 12, an input means 14, a control unit 16, and a monitor (display device) 18.

The CG system 10 of this embodiment is capable of setting at least one of a diffuse transmission plate and a reflection plate in a virtual three-dimensional coordinate space (hereinafter, referred to as virtual space). The diffuse transmission plate diffuses light incident on an object; on the other hand, the reflection plate reflects light so that the light is incident on the object. The diffuse transmission plate and the reflection plate each have preset optical characteristics. The diffuse transmission plate or the reflection plate is set in the virtual space, thereby making it possible to reproduce photo studio lighting, and to obtain an image excellent in textual depiction like a commercial photo as a CG image. The CG system 10 of this embodiment determines whether or not proper lighting is made in accordance with objects.

The CG system 10 of this embodiment has basically the same configuration as a general CG system, except that the CG system 10 has the database unit 12 which stores a set of information on diffuse transmission plate related to its optical characteristics and a set of information on reflection plate related to its optical characteristics.

The database 12 further registers light source type information of a light source and lighting member information on a lighting member.

The light source type information of light source will be explained below. The light source type information of light source includes type information of light source and optical characteristic information of the type of light source. In the present invention, the term “light source information” includes the light source type information and positional information of the light source in a virtual space.

For example, a spotlight or a fluorescent lamp is given as the type of light source.

The optical characteristic in the type of light source is expressed using, for example, a bidirectional reflection distribution function (hereinafter, referred to as BRDF) in terms of a spotlight or a fluorescent lamp.

FIG. 2 is a schematic diagram showing an optical model of the spotlight.

As illustrated in FIG. 2, a spotlight 30 in this embodiment is set as an optical model which has a point light source 32 and a reflection plate 34 surrounding the point light source 32.

Light is reflected by the reflection plate 34, and thereafter, emitted outside. The light is expressed by the BRDF based on the spectral wavelength and strength of the point light source 32 using the optical model described above. The BRDF thus expressed is employed as the optical characteristics of the spotlight 30. In this embodiment, the database unit 12 registers plural spotlights as the type information of light source. The plural spotlights are obtained by variously changing the spectral wavelength and strength of the point light source 32 and the shape and reflectivity of the reflection plate 34.

The fluorescent lamp is modeled like the spotlight, and then, light emitted outside is expressed by the BRDF, and thereafter, the BRDF thus expressed is employed as the optical characteristics of the fluorescent lamp. In this case, the optical model of the fluorescent lamp differs from the point light source 32 of the spotlight shown in FIG. 2 in the following point. The light source is set as a line light source, and the number of light sources is one or plural. The model configuration other than above is the same as that shown in FIG. 2.

Likewise, the database unit 12 in this embodiment registers plural fluorescent lamps as the type information of light source. The plural fluorescent lamps are obtained by variously changing the number, arrangement, spectral wavelength, and strength of line light sources and the shape and reflectivity of the reflection plate 34.

The known light source model is usable as point, line, and plane light sources. The database unit 12 stores various point, line, and plane light sources as the type information of light source.

In this embodiment, the light source may be selected from a spotlight or a fluorescent lamp having the same name as equipment used actually in the photo studio. Preferably, the brightness may be selected using watt. Preferably, the number of the fluorescent lamps may be selected. By doing so, the light source may readily be selected in the same manner as the case of selecting the equipment in the photo studio.

The database unit 12 registers a set of information on the reflection plate reflecting light incident on the object related to information on optical characteristics of the reflection plate. The database unit 12 further registers a set of information on the diffuse transmission plate diffusing light incident on the object related to information on optical characteristics of the diffuse transmission plate. In the present invention, the reflection plate and the diffuse transmission plate are collectively called as lighting members. As described above, lighting member information on the lighting members is registered in the database unit 12.

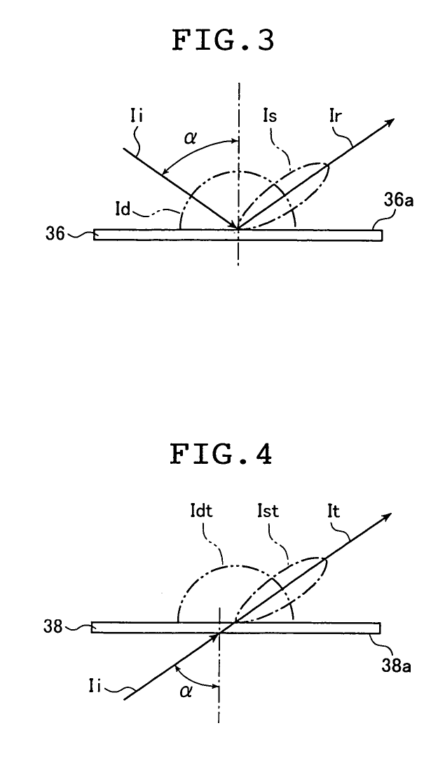

In this embodiment, the optical characteristic of the reflection plate is defined by a model shown in FIG. 3.

FIG. 3 is a schematic diagram to explain the optical characteristic of the reflection plate.

As seen from FIG. 3, if incident light Ii is incident on a surface 36a of the reflection plate 36 at an incident angle of a, the incident light Ii is reflected on the surface 36a, and thereafter, given as reflection light Ir.

The reflection light Ir depends on the incident angle a, the surface roughness of the reflection plate 36, and the wavelength of the incident light Ii. The reflection light Ir becomes specular reflection light Is or diffuse reflection light Id depending on the incident angle α. The distribution of the specular or diffuse reflection light Is or Id is different depending on the material of the diffuse reflection plate 36.

The reflection light Ir in changing the incident angle α of the incident light Ii is measured, and thereby, the BRDF may be obtained. The BRDF thus obtained is used as the optical characteristic of the reflection plate 36.

In view of the circumstances described above, the database unit 12 of this embodiment registers a BRDF for each material of the reflection plate 36. More specifically, the database unit 12 registers optical characteristics corresponding to the names of the reflection plates 36 such as a silver reflector, a mirror reflector, white Kent paper, and a black Decola (trademark) plate. The database unit 12 further registers the shape and size of the reflection plate 36. Accordingly, it is possible to select the kind, shape, and size of the reflection plate.

In this embodiment, the transmission characteristic of the diffuse transmission plate is expressed by, for example, a transmittance distribution function, and defined by a diffuse transmission plate model shown in FIG. 4.

FIG. 4 is a schematic diagram to explain the optical characteristic of the diffuse transmission plate.

As seen from FIG. 4, if the incident light Ii is incident on a surface 38a of the diffuse transmission plate 38 at the incident angle of a, the incident light Ii is transmitted through the plate 38, and thereafter, given as transmission light It.

The transmission light It depends on the incident angle α, the transmission characteristic of the plate 38, the surface roughness thereof, and the wavelength of the incident light Ii. The transmission light It becomes specular transmission light Ist or diffuse transmission light Idt depending on the incident angle α. The distribution of the specular or diffuse transmission light Ist or Idt is different depending on the material of the diffuse transmission plate 38.

The transmission light It in changing the incident angle α of the incident light Ii is measured, and thereby, the transmittance distribution function may be obtained. The transmittance distribution function thus obtained is used as the optical characteristic of the diffuse transmission plate 38.

In view of the circumstances described above, the database unit 12 of this embodiment registers a transmittance distribution function for each material of the diffuse transmission plate 38. More specifically, the database unit 12 registers optical characteristics corresponding to the names of the diffuse transmission plates 38 such as tracing paper, milky-white acrylic plate, and white Kent paper. The database unit 12 further registers the shape and size of the diffuse transmission plate 38.

Note that the database unit 12 also registers the curvature (showing warp) of the diffuse transmission plate. In this case, it is preferable to register the transmittance distribution function in accordance with the curvature. The transmittance distribution function may be obtained by calculation based on the curvature. By doing so, it is possible to select the kind, shape, size, and curvature of the diffuse transmission plate in this embodiment.

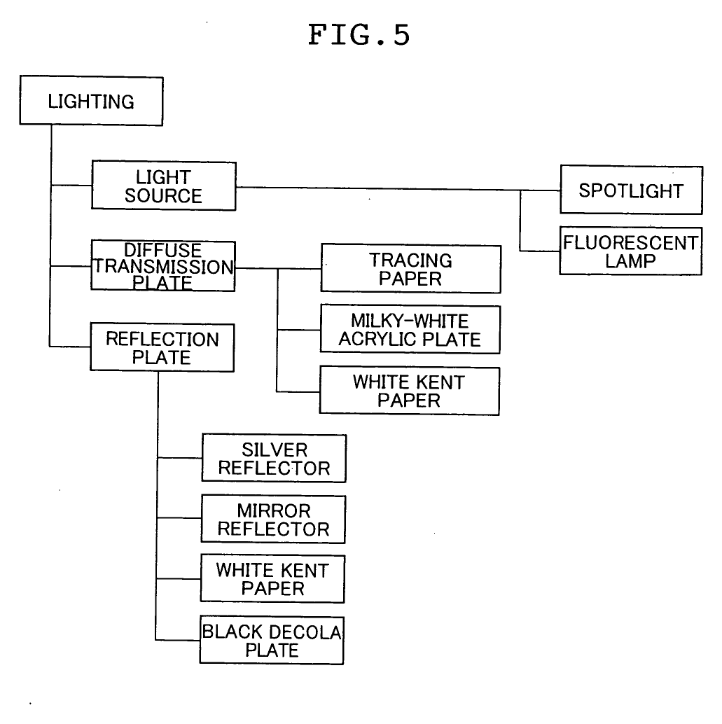

FIG. 5 is a schematic diagram showing individual types of light source and kinds of diffuse transmission plate and reflection plate stored in the database unit of this embodiment.

As depicted in FIG. 5, for example, a spotlight or a fluorescent lamp is selectable as the light source from the database unit 12 of this embodiment. The tracing paper, milky-white acrylic plate, and white Kent paper are selectable as the diffuse transmission plate therefrom. The silver reflector, mirror reflector, white Kent paper, and black Decola (trademark) plate are selectable as the reflection plate therefrom. Persons taking a commercial photo generally know the above-mentioned light sources, diffuse transmission plates, and reflection plates. The optical characteristics relevant to these sources and plates are stored in the database unit 12.

The input means 14 includes a mouse and a keyboard. Users input various pieces of information via the input means 14. The information includes information on the shape, surface, and position of an object to be represented as CG, information on a light source and viewpoint, information on the kind of diffuse transmission plate, and reflection plate, and their arrangement positions. The input means 14 is not specially limited, and may include a tablet.

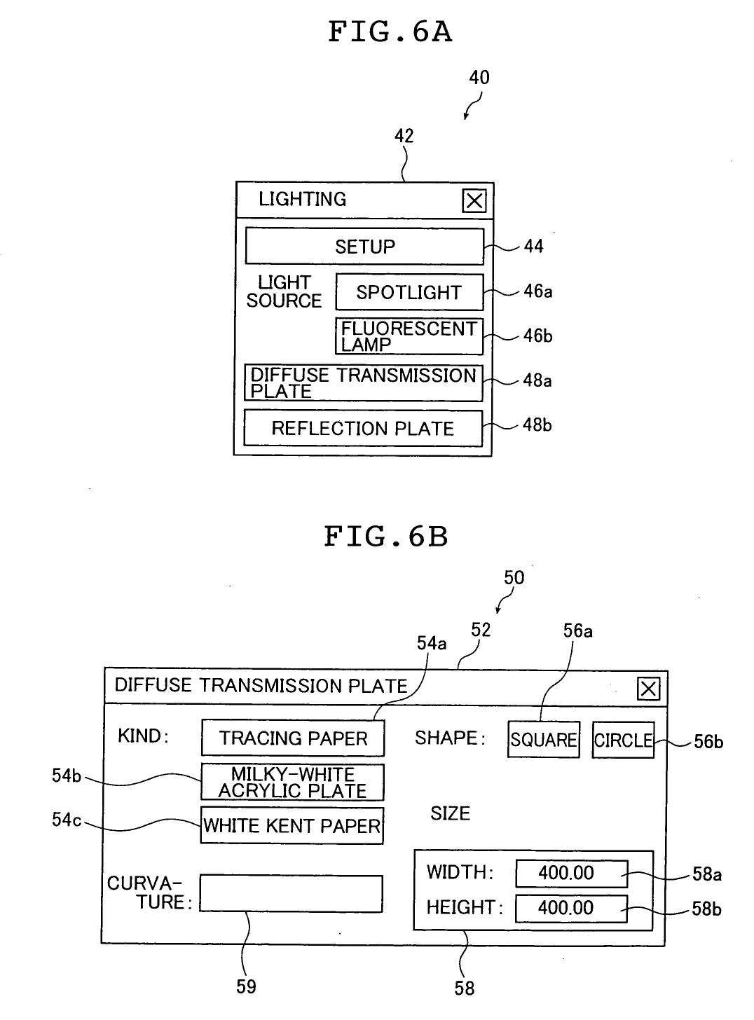

As shown in FIGS. 6A and 6B, a GUI (Graphical User Interface) is used to allow the input means 14 to select the kind of light source, diffuse transmission plate, and reflection plate required for lighting registered in the hierarchy-structure database unit as shown in FIG. 5.

As seen from FIG. 6A, a window 40 (input section) for lighting is displayed on a screen of the monitor 18. The window 40 is provided with a title bar 42 indicating the setup of the lighting condition, and a “set” button 44 for determining the lighting condition. The window 40 is further provided with a “spotlight” button 46a and a “fluorescent lamp” button 46b showing the type of light source. The window 40 is also provided with a “diffuse transmission plate” button 48a and a “reflection plate” button 48b.

In this embodiment, for example, when the user clicks the “diffuse transmission plate” button 48a shown in FIG. 6A, a window 50 shown in FIG. 6B is displayed on the screen. The window 50 is used for setting the kind, shape, and size of the diffuse transmission plate. The window 50 is provided with a title bar 52 indicating the setup of the diffuse transmission plate. The window 50 is further provided with a “tracing paper” button 54a, a “milky-white acrylic plate” button 54b, and a “white Kent paper” button 54c for setting the kind. The window 50 is further provided with a “square” button 56a and a “circle” button 56b for setting the shape. The window 50 further includes an input column 58 for setting the size which includes input fields 58a and 58b for inputting the width and the height. The window 50 further includes an input field 59 for inputting the curvature. The user inputs a positive or negative numerical value to the input field 59 to change the warp direction. When the value “0” is inputted, the diffuse transmission plate is set as being flat.

In this embodiment, numerical values are inputted to the input fields 58a, 58b, and 59 to thereby set the kind, shape, size, and warp (curvature) of the diffuse transmission plate.

This embodiment has been explained with the diffuse transmission plate taken as an example. Setup screens for a light source and a reflection plate are each displayed similarly to the case of the diffuse transmission plate. The type and brightness of the light source are set via the setup screen for light source. The kind, shape, and size of the reflection plate are set via the setup screen for the reflection plate.

The control unit 16 controls the database unit 12, the input means 14, and the monitor 18, and further includes an operational section 20.

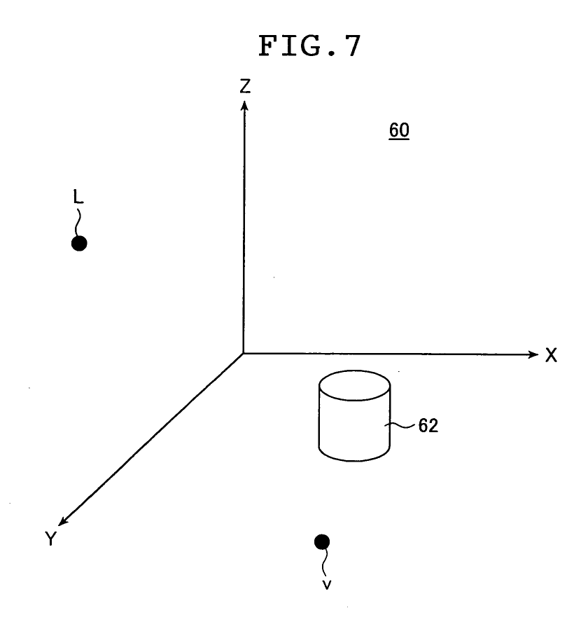

As shown in FIG. 7, the control unit 16 arranges an object based on the information given below. In this case, the control unit 16 arranges the object in a virtual space (virtual three-dimensional coordinate space) 60 using a virtual three-dimensional orthogonal coordinate system (X-, Y-, and Z-axes) in a screen of the monitor 18. Thereafter, the control unit 16 displays the object as a two-dimensional image on the screen. The above-mentioned information includes the surface information of the object formed in the virtual space on the screen of the monitor 18 inputted by the input means 14, the positional information of the object in the virtual space, the light source information, the viewpoint information, and information on the kinds and arrangement positions of the reflection plate and the diffuse transmission plate.

The shape information of the object refers to data for displaying an object having a three-dimensional shape on the monitor 18.

The surface information of the object refers to the surface characteristic thereof. For example, the surface roughness, surface material, and mirror or diffuse reflectivity of the surface are given.

The positional information of the object refers to the position of an object 62 in the virtual space 60. The positional information of the object is expressed using a coordinate system having X-, Y-, and Z-axes in this embodiment.

The light source information refers to the type and position of the light source in the virtual space 60. The position of a light source L shown in FIG. 7 is expressed using the coordinate system having X-, Y-, and Z-axes.

The viewpoint information refers to the position, angle, and magnification of a camera used for taking a photo of the object 62 in the virtual space. In this embodiment, the viewpoint information is a point shown by a viewpoint v in FIG. 7, and relates to the magnification of the object 62 at the viewpoint v. The viewpoint v is also expressed using the coordinate system having X-, Y-, and Z-axes.

The information on the arrangement position of the reflection plate or the diffuse transmission plate refers to a position of the plate in the virtual space 60. The information on the arrangement position is expressed using the coordinate system having X-, Y-, and Z-axes.

The operational section 20 of the control unit 16 is provided with a storage portion 22. The storage portion 22 stores the surface information and the positional information of the three-dimensional object displayed as a two dimensional image on the screen, the light source information, the view point information, and the information on the kinds and arrangement positions of the reflection plate and the diffuse transmission plate.

The operational section 20 carries out modeling based on the shape information of the object to obtain model data on an object that may be displayed on the screen of the monitor 18. The representation by the modeling is not specially limited. For example, a polyhedron model, wire frame model, surface model, solid model, and metaball (gray-level function model) are given.

Rendering is carried out based on model data of the object obtained by the modeling, the optical characteristic information and positional information of the type of light source, the surface information of the object, the viewpoint information (camera angle), and the information on the arrangement positions of the reflection plate and the diffuse transmission plate.

According the rendering, the model data (three-dimensional image data) is displayed as a two-dimensional image on the screen of the monitor 18. In this embodiment, for example, ray tracing is employed. In the present invention, the rendering is not specially limited, and known rendering is variously usable.

In the manner described above, it is possible to obtain a two-dimensional image data of the object viewed from the camera angle.

The image data is, for example, saved in the storage portion 22 while being outputted to the monitor 18 to be displayed as a two-dimensional image.

The monitor 18 may be any other form as long as it has a function of displaying the two-dimensional image data prepared by the operational section 20 as an image. Thus, the monitor 18 is not specially limited. For example, a CRT, an LCD, a PDP, and an organic EL display are given as the monitor 18.

In this embodiment, the user selects the light source and lighting members, and inputs their arrangement positions in the virtual space via the input means. In this case, the user may previously register information on the light source and lighting member frequently used and on their arrangement positions in the virtual space in the database unit 12 (see FIG. 1).

Further, the user may register in the database unit 12 information on the light source and lighting member preset by a user and on their arrangement positions in the virtual space in a state of giving a studio name to the information.

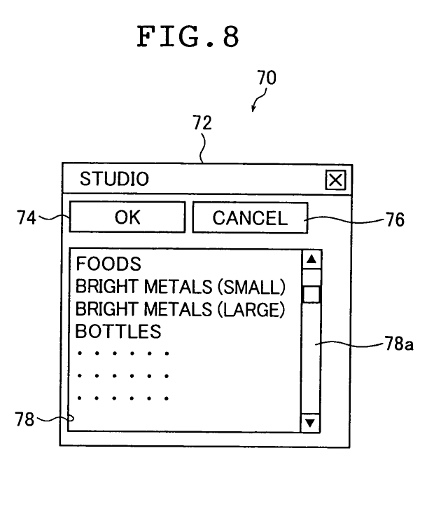

FIG. 8 is a schematic diagram showing an input section for selecting the studio name registered in the database unit of this embodiment.

As seen from FIG. 8, a window (input section) 70 is provided with a title bar 72 indicating the selection of a studio name. The window 70 is further provided with an “OK” button 74 for determining the selection and a “cancel” button 76 for canceling the determination.

The window 70 is further provided with a list box 78 for displaying a predetermined number of studio names registered using predetermined names. The list box 78 includes a scroll bar 78a. If all is not displayed in the list box 78 because the number of registered studio names is too large, it is possible to browse all of studio names registered in the database unit 12 by scrolling the scroll bar 78a.

In this embodiment, for example, the user selects an item “bottles” shown in the list box 78, and then clicks the “OK” button 74. Based on preset data for “bottles” registered in the database unit 12 (see FIG. 1), the control unit 16 (see FIG. 1) arranges the registered light source and lighting members (diffuse plate and/or reflection plate) on the predetermined position in the virtual space. Thus, the user selects a desired studio name from the studio name list, and thereby, it is possible to omit the operation for selecting a light source and lighting members and for arranging them in the virtual space. In particular, if plural light sources and lighting members exist and the operations for selecting and arranging them are troublesome, it is effective to omit time and labor.

The following is an explanation about the computer graphics reproducing method according to the present invention. Note that a program of the present invention is provided for implementing the computer graphics reproducing method detailed below on a computer or a computer graphics system.

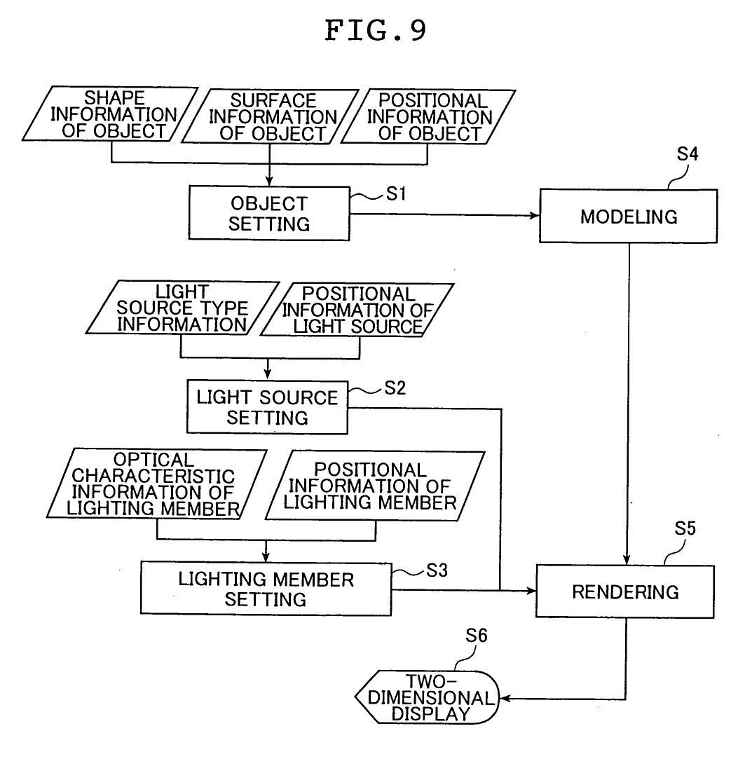

FIG. 9 shows a flowchart of the computer graphics reproducing method of this embodiment. An exemplary case where the computer graphics reproducing method is implemented on the computer graphics system (CG system) 10 shown in FIG. 1 will be described below.

First, an object to be reproduced according to the computer graphics reproducing method is set (S1). In the object setting S1, the shape information, surface information and positional information of the object are inputted through the input means 14 of the CG system 10 shown in FIG. 1 and the information on the object (hereinafter, referred to as object information) is stored in the storage portion 22. As described above, the shape information of object is data for displaying an object having a three-dimensional shape on the monitor 18, and includes for example information on the size, shape or the like of the object. Also as described above, the surface information of object is information on the surface characteristics of the object. The surface roughness, surface material, or mirror or diffuse reflectivity of the surface can be used for the surface information. The shape information and surface information of objects can be registered previously in the database unit 12 in relation to the objects. When an article is specified, the shape information and surface information on the objects corresponding to the article are displayed on the monitor so that a user selects the shape information and surface information on a specific object by designation. The selected shape information and surface information are stored in the storage portion 22. In the setting of the positional information of the object, X, Y and Z coordinates in the virtual space are inputted through the input means 14 and the position of the object in the three-dimensional virtual space is set in the storage portion 22. An Object in the virtual space may be displayed on the monitor 18 and moved in the virtual space by the input means such as a mouse to set the positional information of the object.

Next, a light source used for reproducing the object in the virtual space is set (S2). In the light source setting S2, the light source type information and the positional information of the light source (which are hereinafter collectively referred to as light source information) are inputted through the input means 14 and stored in the storage portion 22. As described above, the light source type information includes the information on the type of light source and the information on the optical characteristics for the type of light source. More specifically, the type (e.g., spotlight or fluorescent lamp), shape and quantity of light of the light source, and number of light sources are inputted through the input means 14 as the light source type information to be stored in the storage portion 22. The information on the optical characteristics for the type of light source are used for example to express the optical characteristics of light source by a bidirectional reflection distribution function (BRDF) or a transmittance distribution function.

Subsequently, a lighting member used for reproducing the object in the virtual space is set (S3). In the lighting member setting S3, the information on the kind and arrangement position of the lighting member is inputted through the input means 14 to be stored in the storage portion 22. The information on lighting members is registered in the database unit 12 of the CG system 10 in relation to the information on the optical characteristics of these lighting members. Based on the kind of the lighting member inputted through the input means 14, the control unit 16 can extract the information on the optical characteristics of the inputted light member from the database unit 12. X, Y, and Z coordinates in the virtual space are inputted through the input means 14 for the arrangement position of the lighting member, whereby the position of the lighting member in the virtual space is specified.

Then, modeling is carried out based on the object set in the object setting (S4). The modeling S4 is carried out in the operational section 20 of the CG system 10 shown in FIG. 1. Model data obtained by the modeling is stored in the storage portion 22.

Next, rendering (S5) is carried out based on the light source information set in the setting of the light source S2, the information on the arrangement position of the lighting member set in the setting of the lighting member S3, the information on the optical characteristics of the lighting member, and the model data obtained by the modeling S4. The rendering S5 is carried out in the operational section 20 as well as the modeling. The image data obtained by the rendering S5 is stored in the storage portion 22 of the CG system 10 and is outputted to the monitor 18, on which a two-dimensional image is displayed. In this way, the two-dimensional image of the object reproduced on the monitor 18 is excellent in the transparent, three-dimensional and glossy effects and has the same textural depiction as that of the commercial photo.

The setting object S1, the light source setting S2, the lighting member setting S3, modeling S4, rendering S5 and monitor display S6 were carried out in this order in the above embodiment. However, this is not the sole case of the present invention. The object setting, the light source setting and the lighting member setting may be carried out in any order as long as the object is set before the modeling is carried out, and the setting of the light source, setting of the lighting member and modeling are carried out before the rendering.

Viewpoint information for specifying the position, angle and magnification of a camera used for taking a photo of the object may be set in the virtual space to carry out the rendering based on the viewpoint information, light source information, lighting information and model data.

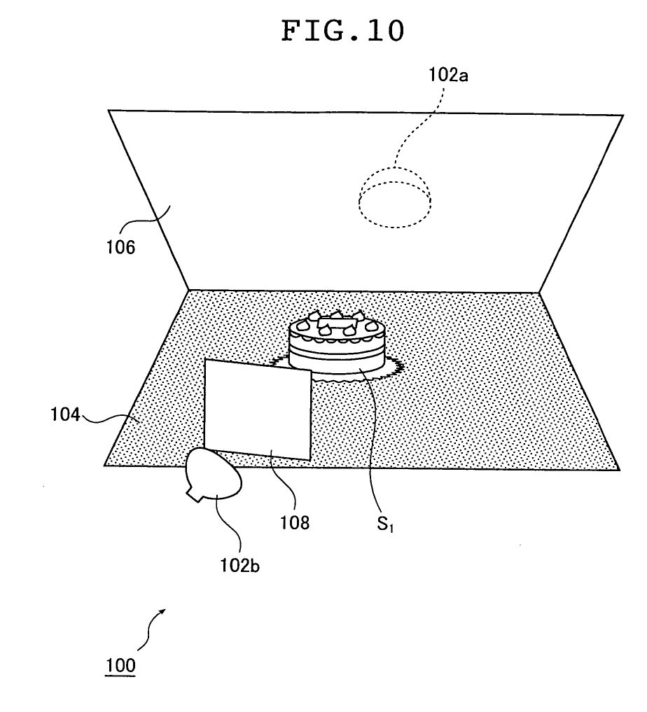

The computer graphics reproducing method will be more specifically described below. FIGS. 6A and 6B are schematic diagrams showing the input procedure by the input means according to this embodiment of the present invention. FIG. 10 is a schematic view showing a state in which a light source, a lighting member, and a cake are arranged in the virtual three-dimensional coordinate space in the computer graphics reproducing method of this embodiment.

As illustrated in FIG. 10, lighting for depicting a cake S₁ with excellent texture will be explained as an example.

First, the shape of the cake S₁ is inputted via the input means 14 (see FIG. 1). The input means 14 inputs the position of the cake S₁ in a virtual space 100, the mirror reflectivity on the surface of the cake S₁, and the diffuse reflectivity thereof.

A spotlight 102a is next selected as a first light source. In this case, the spotlight 102a has a brightness of 800 watts, for example. The position of the spotlight 102a in the virtual space 100 is inputted.

A spotlight 102b is then selected as a second light source. In this case, the spotlight 102b has a brightness of 300 watts, for example. The position of the spotlight 102b in the virtual space 100 is inputted.

A black Decola (trademark) plate 104 is selected as the reflection plate. The square is selected as the shape of the black Decola (trademark) plate 104. The position of the black Decola (trademark) plate 104 is set under the cake S₁ in the virtual space 100.

A sheet of white Kent paper 106 is selected as the diffuse transmission plate. The square is selected as the shape of the white Kent paper 106. The position of the white Kent paper 106 is set between the spotlight 102a and the cake S₁ in the virtual space 100.

A sheet of tracing paper 108 is selected as the diffuse transmission plate. The square is selected as the shape of the tracing paper 108. The position of the tracing paper 108 is set above the black Decola (trademark) plate 104 and between the spotlight 102a and the cake S₁ in the virtual space 100.

Next, a photographic camera angle (not shown) is set.

As illustrated in FIG. 10, the cake S₁, spotlights 102a, 102b (light source), reflection plate, and diffuse transmission plate are arranged in the virtual space formed on the screen of the display section. In the arranged state, rendering in the camera angle (viewpoint) is carried out using, for example, ray tracing. According to the rendering, it is possible to obtain image data of the two-dimensional image displayed on the screen of the monitor 18 (see FIG. 1).

Based on the image data thus obtained, the cake S₁ is displayed as a two-dimensional image on the screen of the monitor 18.

In this embodiment, the arrangement positions of the diffuse transmission plate and the reflection plate are set in the virtual space in addition to the cake S₁ (object) and light source. In this case, the diffuse transmission plate diffuses light incident on the cake S₁ from the light source. The reflection plate reflects light incident on the cake S₁ from the light source. Further, the shooting position of camera is set. The settings serve to obtain lighting capable of providing excellent texture of the cake S₁. Rendering is carried out based on the settings; therefore, it is possible to obtain the cake S₁ excellent in texture, that is, a CG image reproduced to have a quality equivalent to the commercial photo.

In this embodiment, the database unit stores a set of information on optical characteristics of the diffuse transmission plate or the reflection plate associated with information on these plates. Thus, when the diffuse transmission plate or the reflection plate is selected, its optical characteristics are simultaneously determined. In this embodiment, the diffuse transmission plate or the reflection plate is expressed using names used usually in the photo studio. By doing so, even persons who have no optical knowledge can select the diffuse transmission plate or the reflection plate like in a normal photo studio. As a result, the user can readily operate the CG system 10. In addition, the diffuse transmission plate or the reflection plate is arranged at the predetermined position in the virtual three-dimensional coordinate space. By doing so, it is possible to reproduce the same lighting as the photo studio without understanding optical characteristics, thereby making it possible to obtain the lighting effect, which is required with commercial photo, and readily produce a CG image excellent in textural depiction.

Next, another embodiment of the present invention will be described below. That is, this embodiment relates to lighting for preferably representing (reproducing) an object having metallic texture.

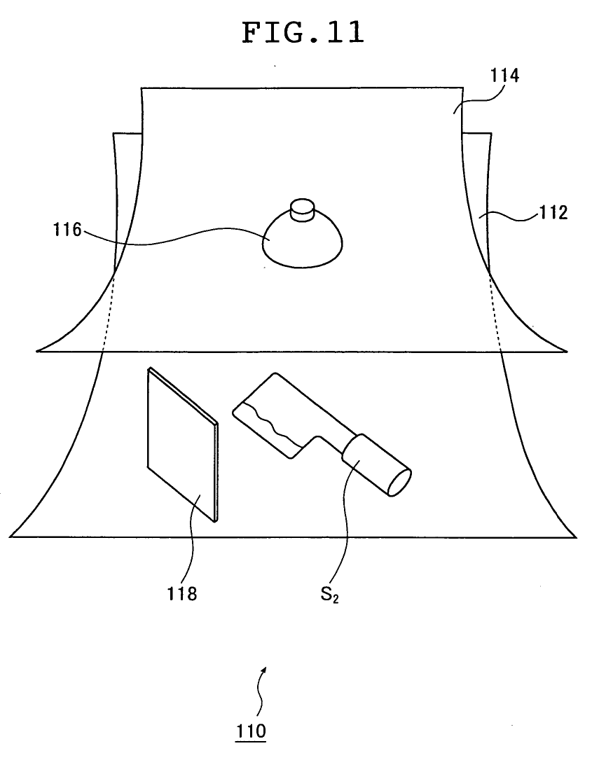

FIG. 11 is a schematic view showing a state that a light source, a lighting member, and a kitchen knife are arranged in the virtual three-dimensional coordinate space in a computer graphics reproducing method according to another embodiment of the present invention. Note that a program of the present invention is provided for implementing the computer graphics reproducing method described below.

In this embodiment, components arranged in a virtual space 110 only differ from the above embodiment, and the method of selecting the components is the same; therefore, the details are omitted. In this embodiment, the CG system 10 (see FIG. 1) is also applicable.

In this embodiment, a sheet of white Kent paper 112 is arranged under a kitchen knife S₂ in the virtual space 110 as shown in FIG. 11. The white Kent paper 112 is pulled up, and warps so that the kitchen knife S₂ has no shadow.

A spotlight 116 as the light source is arranged above the kitchen knife S₂. The spotlight 116 has a brightness of 1200 watts, for example. A sheet of tracing paper 114 is interposed between the spotlight 116 and the kitchen knife S₂. The tracing paper 114 warps to be projected toward the kitchen knife S₂. A silver reflector 118 is arranged on a side of the blade of the kitchen knife S₂.

In this embodiment, the arrangement positions of the tracing paper, silver reflector, and white Kent paper are set in the virtual space in addition to the kitchen knife S₂ (object) and light source. In this case, the tracing paper diffuses light incident on the kitchen knife S₂ from the light source. The silver reflector reflects light incident on the kitchen knife S₂ from the light source. Further, the shooting position of camera is set. The settings serve to obtain lighting capable of providing excellent texture of the kitchen knife S₂. Rendering is carried out based on the settings; therefore, it is possible to obtain the kitchen knife S₂ having brilliantly metallic texture, that is, a CG image reproduced to have a quality equivalent to the commercial photo.

The embodiments have been explained in detail above about the computer graphics system, the computer graphics method, and the computer graphics reproducing program according to the present invention. However, the present invention is not limited to the embodiments, and of course, various modifications and changes may be made within the scope without departing from the gist of the present invention.

According to the embodiments, lighting members used in the studio for taking the commercial photo are arranged in the virtual space, and thereafter, rendering is carried out. Therefore, it is possible to readily determine whether or not lighting effects are properly provided.

Lighting members are only arranged in the virtual space in the same manner as being set in the studio, and thereby, it is possible to readily determine whether or not lighting effects are properly provided. Thus, persons having no special optical knowledge can readily obtain a CG image excellent in textural depiction.

According to the present invention, the following various studios may be previously registered in the database unit 12. For example, the studios have lighting conditions, which are provided in accordance with object characteristics having various textures such as metal, food, or glass. By doing so, the user can select a desired studio in accordance with the texture of the CG object to be reproduced (see FIG. 8). Therefore, persons having no special optical knowledge can more readily obtain a CG image excellent in textural depiction.

The present invention is preferable to simulation for confirming lighting effect in the photo studio. The simulation is carried out, and thereby, it is possible to confirm the lighting effects before the equipment are actually arranged in the photo studio.

In the present invention, data necessary for carrying out modeling and rendering is only inputted via the input means. Thus, the procedure for inputting the data is not specially limited. For example, all data is inputted, and thereafter, modeling and rendering may be carried out. In addition, modeling is carried out, and thereafter, rendering may be carried out after necessary data for rendering is inputted.

1. A computer graphics system displaying a three-dimensional image of an object created in a virtual three-dimensional coordinate space on a screen of a display device as a two-dimensional image of the object, comprising:
a database unit which stores at least one set of lighting member information on a lighting member for controlling light incident on said object arranged in the virtual three-dimensional coordinate space and optical characteristic information on optical characteristics of said lighting member;
input means which inputs and instructs shape information of said object created in the virtual three-dimensional coordinate space, surface information of said object, positional information of said object within the virtual three-dimensional coordinate space, light source information of a light source arranged in the virtual three-dimensional coordinate space, viewpoint information for displaying said object as said two-dimensional image, information on a kind of said lighting member, and positional information of said lighting member arranged in the virtual three-dimensional coordinate space; and
an operational section which generates image data of said object to be displayed as said two-dimensional image on the screen based on said shape information of said object, said surface information of said object, said positional information of said object, said light source information, said viewpoint information, said lighting member information, said optical characteristic information of said lighting member, and said positional information of said lighting member.

2. The computer graphics system according to claim 1, wherein said input means comprises an input section for inputting at least one of said light source information on said light source arranged in the virtual three-dimensional coordinate space and said lighting member information, and said input section is displayed on the screen of said display device.

3. The computer graphics system according to claim 1, wherein said lighting member comprises one of a diffuse transmission plate and a reflection plate.

4. The computer graphics system according to claim 1, wherein said optical characteristics of said lighting member are expressed using one of a bidirectional reflection distribution function and a transmittance distribution function.

5. The computer graphics system according to claim 1, wherein said light source information comprises information on a type of the light source and positional information in the virtual three-dimensional coordinate space.

6. A computer graphics reproducing method for displaying a three-dimensional image of an object created in a virtual three-dimensional coordinate space on a screen of a display device as a two-dimensional image of the object, comprising the steps of:
setting shape information and surface information of said object, and positional information of said object in the virtual three-dimensional coordinate space;
setting light source information which includes type information of a light source arranged in the virtual three-dimensional coordinate space and positional information indicating an arrangement position of said light source in the virtual three-dimensional coordinate space;
setting lighting member information of a lighting member for controlling light incident on said object, optical characteristic information on optical characteristics of said lighting member, and positional information of said lighting member indicating an arrangement position of said lighting member;
modeling said object based on said set shape information of the object to obtain object model data;
rendering said object model data based on said light source information, said lighting member information, said optical characteristic information of said lighting member, and said positional information of said lighting member; and
displaying said object on the screen as the two-dimensional image based on image data obtained from said rendering.

7. The computer graphics reproducing method according to claim 6, wherein the optical characteristics of said lighting member are expressed using one of a bidirectional reflection distribution function and a transmittance distribution function.

8. A computer graphics program for creating image data for displaying a three-dimensional image of an object created in a virtual three-dimensional coordinate space on a screen of a display device as a two-dimensional image, running on a computer graphics system including the display device and a computer, said computer graphics program comprising the steps of:
modeling said object based on shape information of the object having been set through inputting to obtain object model data;
rendering said object model data based on positional information of said object in the virtual three-dimensional coordinate space, surface information of said object, inputted information on a light source, lighting member information on a lighting member for controlling light incident on said object, information on optical characteristics of said lighting member, positional information of said lighting member in the virtual three-dimensional coordinate space; and
displaying said object on the screen as the two-dimensional image based on image data obtained from the rendering.

9. The computer graphics program according to claim 8, wherein said light source information includes type information of said light source and positional information indicating a position of said light source arranged in the virtual three-dimensional coordinate space.

10. The computer graphics program according to claim 9, wherein said optical characteristics of said lighting member are expressed using one of a bidirectional reflection distribution function and a transmittance distribution function.
